(19) United States
(12) Patent Application Publication
(10) Pub. No.: US 2008/0256712 A1
(43) Pub. Date: Oct. 23, 2008

(54) Versatile cushion device

(76) Inventor: Conghua Li, Markham (CA)

Correspondence Address: CONGHUA LI, 17 Talisman Cres., Markham, ON, L3P 2C8, CA

(21) Appl. No.: 12/213,806

(22) Filed: Jun. 25, 2008

Related U.S. Application Data
(63) Continuation-in-part of application No. 10/690,558, filed on Oct. 23, 2003.
Application No. 10/690,558 is a continuation-in-part of application No. 10/313,269, filed on Dec. 9, 2002, now Pat. No. 6,760,933.

(51) Int. Cl. A47G 9/10; A61G 5/12

(52) U.S. Cl. 5/652.1

(57) ABSTRACT

A cushion device for use when placed in seats, in beds, or on floors, comprising a flexible hollow, enclosed shell having two large opposed surfaces, the shell capable of containing gas or liquid without substantial leakage, and having a port or a plurality of ports that can allow gas or liquid to enter into or to escape from the shell, the port or ports each being provided with closure means which can substantially prevent entry and escape of gas or liquid from the shell. The shell, when empty, can maintain a substantially flat form when held by one hand from an edge of the shell for the ease of handling, storage or transportation, and can allow a substantial adjustable expansion under working condition, due to the provision of a stiffener, a cover or its inherent firmness, rigidity or stiffness. It may be used for heat treatment, cooling treatment and for back, spine and extremities exercises and support of the user.

### RELATED APPLICATIONS

This application is a continuation-in-part of U.S. patent application Ser. No. 10/690,558 filed on Oct. 23, 2003 which is a continuation-in-part of U.S. patent application Ser. No. 10/313,269, filed on Dec. 9, 2002, now U.S. Pat. No. 6,760,933, the specifications of which are incorporated herewith in their entirety.

### FIELD OF INVENTION

This invention relates to cushion or pillow devices for the comfort of persons while sitting on chairs, benches, stools, or sofas, or lying in beds or on floors; for example for supporting persons' back and spine, or for stimulating or exercising person's back and spine, especially the hard-to-reach deep and small muscles in a person's back and spine, or for maintaining person's posture, or for exercising ankles, knees, legs, arms, equilibrium or core stability, in chairs, seats, benches, stools, sofas, or on floors, or for maintaining a healthy alignment, especially sideways alignment, between the head and spine of a person in bed while sleeping, or the like. Since the primary purpose of the invention is supporting, exercising or soothing the upper and lower back and other body parts, the device will hereinafter be referred to as a “cushion” or “cushion device”.

### DISCUSSION OF PRIOR ART

Without proprioceptive stimulation and exercises, sitting generally weakens a person's back, particularly lower back or so-called lumbar region. Over 80% of people experience or will experience significant lower back pain at least once in their lifetime. While stability balls and their alternatives can provide a proprioceptive stimulation, they have some drawbacks e.g. risk of falling, and are too cumbersome to adjust and transport, such as from office to home, or be brought to theatres, or be used in cars or airplanes.

Also known are water-filled pillows, or pillows which may be used to provide proprioceptive stimulation and support, and which function somewhat similarly to waterbeds. These devices usually are difficult to handle and to transport from one location to another, or lack rigidity when empty. Such pillows are shown in the following U.S. patents:

U.S. Pat. No. 3,900,910, issued Aug. 26, 1975 to Nakata;

U.S. Pat. No. 4,724,560, issued Feb. 16, 1988 to Christie;

U.S. Pat. No. 4,896,388, issued Jan. 13, 1990 to Bard;

U.S. Pat. No. 5,642,544, issued Jul. 1, 1997 to Munoz, and

U.S. Pat. No. 6,044,506, issued Apr. 4, 2000 to Valene

It is an object of the present invention to provide a device designed to provide sufficient, ergonomic, proprioceptive stimulation, lumbar support, core stability exercises and functional balance training to persons while sitting, sleeping, lying down or standing, hence to improve their health and comfort, the device being relatively easy to handle and transport.

It is another object of the invention to provide posture support and back support to a sitting person.

It is another object of the invention to provide a portable and adjustable proprioception device (the term “proprioception used herein to define exercises of spine, ankles, knees, legs, arms and associated muscles and nervous systems) to replace cumbersome and risky plastic stability balls and balance trainers, so people can conduct exercise and protect their health and productivity virtually throughout the day and everywhere they go—at home, or at work, or at theaters, or even in cars and airplanes.

Further objects and advantages of the invention will become apparent from the ensuing description and drawings.

### SUMMARY OF THE INVENTION

In accordance with one aspect of the invention, there is provided a cushion device which comprises:

a flexible, hollow, enclosed shell having two large opposed surfaces, the shell being capable of containing gas or liquid without substantial leakage, at least one port in the shell for ingress or egress of gas or liquid, said port or ports being provided with closure means, and

means for maintaining a substantially planar, or flat, form of the shell (and thus the device) when the shell is substantially empty (or has little or no internal volume) and no substantial bending force is applied onto the shell.

In another aspect of the invention, there is provided a cushion device which comprises a flexible, hollow, enclosed shell having two large opposed surfaces, the shell being capable of containing gas or liquid without substantial leakage, at least one port in the shell for ingress or egress of gas or liquid, said port or ports being provided with closure means, and means for maintaining a substantially planar, or flat, form of the shell (and thus the device) when the port or ports are open to ambient atmosphere and no substantial bending force is applied onto the shell.

In one embodiment of the invention, the means for maintaining the shell in a substantially planar (flat) form with little or no internal volume may be stiffness, firmness or rigidity of the shell, the stiffness, firmness or rigidity not precluding either the filling of the shell with a fluid, or bending, folding or rolling up the shell using a reasonable force.

In another embodiment of the invention, the means for maintaining the shell in a substantially planar (flat) form when substantially empty is a substantially two-dimensional stiffening element associated with the shell, the stiffening element having sufficient firmness, rigidity or stiffness to maintain the shell in a substantially flat position when the shell is substantially empty and no substantial bending force is applied onto the shell, but being flexible or resilient enough to allow a deformation of the shell when a reasonable force is applied thereon.

In an embodiment of the invention, the stiffening element is a perforated, foraminous, openwork sheet, flat netting material or lattice structure, preferably made of a plastic material, of a size corresponding to the internal dimensions of the shell.

In another embodiment, the stiffening element is a solid flat sheet also preferably made of a plastic material.

The stiffening element may be entirely or partly detached from the shell or may be integrated therewith, thereby forming a part of the shell. The element may be disposed inside or outside the shell substantially in parallel with its two large surfaces.

In yet another embodiment, the means for maintaining the shell in a substantially flat form is a cover enveloping the shell, the cover having a firmness, rigidity or stiffness sufficient to that purpose but not precluding the filling of the shell with a fluid or bending, folding or rolling up of the shell using a reasonable force. The firmness, rigidity or stiffness may be due to a selection of material of the cover or the cover may be associated with a stiffening element.

The shell is preferably made of a polymeric material by means of a known technology such as heat sealing, welding, adhesive bounding, blow molding, rotational molding, vacuum forming or injection molding.

The cover may be made of any conventional material used for such purpose e.g. a fabric, leather, man-made leather or a plastic material. When the shell alone has sufficient firmness, rigidity or stiffness needed to maintain the flat form of the shell, the cover may mainly serve decorative, protective or texture-variation purposes.

The properties of the material(s) of the cushion structure are selected for the walls of the shell to maintain some elasticity to allow for inflation of the cushion, and for a spontaneous or gently forced return of the shell, when inflated and subsequently emptied, to the flat form. It will be understood that the cushion device maintains some rigidity or stiffness when empty, the rigidity or stiffness allowing for maintaining the flat form of the cushion when held e.g. at an edge in a horizontal plane (i.e. the cushion will sag or bend relatively little).

In accordance with another aspect of the invention, there is provided a method of therapeutic stimulation of a person's body, and particularly lower back region, the method comprising:

providing an inflatable cushion having a shell with a length from about 15 to about 19 in. in length and about 10 to 16 in. in width,

inflating the cushion partly or fully with a fluid so that the height, or thickness of the cushion when placed on a flat surface is from about 0.5 to about 1.5 in., and

using the cushion by sitting on it whereby the occupant performs or receives one or more exercises selected from the group consisting of proprioceptive, neuromuscular, functional balance, equilibrious, isotonic, isometric, therapeutic and range-of-motion exercises of the lumbosacral spine and muscles, pelvis, abdomen, gluteal and thigh regions to promote enhanced mobility, stability, strength, proprioception, equilibrium, functional balance and other related health conditions of the occupant's body in comparison to passive sitting.

In accordance with another aspect of the invention, there is provided a method of therapeutic stimulation of a person's body, and particularly lower back region, the method comprising:

providing an inflatable cushion having a shell with a length from about 15 to about 28 in. in length and about 10 to 18 in. in width,

inflating the cushion partly or fully with a fluid so that the height, or thickness of the cushion when placed on a flat surface is from about 1 in. to about 2 in., and

using the cushion by standing on it whereby the occupant performs or receives one or more exercises selected from the group consisting of proprioceptive, neuromuscular, functional balance, equilibrious, isotonic, isometric, therapeutic and range-of-motion exercises of the ankle, knee, leg, thigh, gluteal, pelvis, abdomen, spine, trunk, upper body and upper extremity regions to promote enhanced mobility, stability, strength, proprioception, equilibrium, functional balance and other related health conditions of the occupant's body, in comparison to standing on conventional balance training devices such as balance boards or balance balls.

### DEFINITIONS

For the purpose of the present specification,

“substantially planar, or flat, form” means a plate-like structure with the major surfaces essentially parallel and distinctly greater than the minor surfaces, the thickness of which is basically determined by the thickness of the material it is made of and not by a volume of a fluid residing therein;

“internal volume” means volume of a fluid contained between the walls of the shell, with an allowance for the volume necessitated by an insert, if any;

“reasonable force” means a force exertable by a typical user of the cushion of the invention without undue strain;

“hollow” denotes a shell that is suitable for a relatively easy ingress and egress of a fluid to and from the shell, notwithstanding any insert or stiffening element occupying a minor portion of the space inside the shell. Such insert should be of such structure and disposed so as not to substantially obstruct the ingress and egress of the fluid to and from the shell.

Hereinafter, the term “bending” is used to denote also folding, rolling up or a similar deformation for the purpose of storage, transportation, handling or the like.

### BRIEF DESCRIPTION OF THE DRAWINGS

The invention will be described in more detail by way of the following description with reference to the drawings, in which

FIG. 1 is a perspective view of the cushion device, without any cover;

FIG. 2 is a cross-sectional view of the device of FIG. 1 without an insert;

FIG. 3 is a cross-sectional view of the device of FIG. 1 with a loose insert;

FIG. 3a is a cross-sectional view of a cushion device with an insert embedded in the shell;

FIG. 4 is an illustration of an exemplary insert (stiffening element);

FIG. 4a shows another embodiment of the insert;

FIG. 5 illustrates a device of the invention having a shell enveloped in a cover;

FIG. 5a shows an embodiment of the device with a shell, insert inside the shell and a cover surrounding the shell;

FIG. 6 is a back view of a cushion device with a cover;

FIG. 7 shows a back view of another embodiment of the cushion with a cover;

FIG. 8 is a back view of yet another embodiment of the cushion,

FIG. 9 is a cross-sectional view along the lines A-A of the cushion of FIG. 8;

FIG. 10 illustrates the use of the cushion device for therapeutic heating or cooling (fomentation or cryotherapy),

FIG. 11 illustrates the use of the cushion device for lumbar muscular and spinal exercising (proprioception),

FIG. 12 illustrates the use of the cushion device for lumbar support in a dry environment such as on a sofa.

FIG. 13 illustrates the use of the cushion device for supporting head in bed or on ground, and

FIG. 14 illustrates the use of the cushion device for providing functional balance training, as well as knee and ankle rehabilitation.

### DETAILED DESCRIPTION OF THE INVENTION

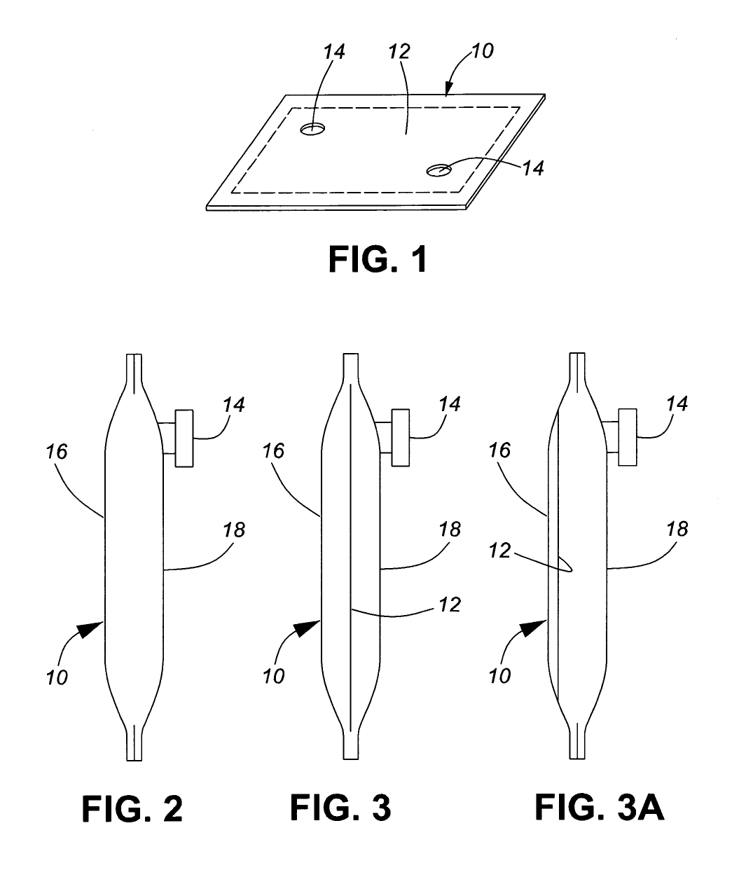

FIG. 1 is an illustration of an embodiment of the cushion device without a cover. The device has a flexible hollow shell 10, a flat sheet-like semi-rigid insert 12 within the shell (shown in phantom lines), and one or a plurality of gas and liquid control ports 14 (two shown in FIG. 1). In alternative embodiments, which do not require separate illustration, only one port 14 may be provided. The flexible hollow shell 10 is made of a plastic, plastic coated, or plastic laminated material and is substantially air- and watertight when the port or ports are closed.

As shown in FIGS. 2 and 3, the shell defines two opposite large surfaces 16, 18. In the embodiment of FIG. 2, the shell 10 is made of a relatively stiff material or is of sufficient thickness to maintain a substantially flat form when the shell 10 is substantially empty and no bending force is applied onto the shell. To clarify the “flat form” even more, the cushion defines a virtually flat structure when empty and held at an edge with one hand, with the shell positioned either horizontally or vertically, and it can be placed on its edge without collapsing.

The rigidity, firmness or stiffness of the cushion is maintained even when the cushion is little or not inflated. It is advantageous when the cushion does not sag when placed “upright” against the backseat of the chair etc. to be used as a lower back support.

FIG. 2 shows a spacing between the two large surfaces 16, 18 for clarity only. When the shell is empty and the valve(s) 14 are open, the surfaces 16, 18 abut each other.

In the embodiment of FIG. 3, the shell may be made of a material having little rigidity or stiffness. The shell will maintain a substantially flat form, as defined above, due to the provision of a stiffening insert 12. In FIG. 3, the insert 12 is shown as unattached to the shell. In FIG. 3a, the insert 12 is embedded into one of the surfaces 18 using a conventional technique e.g. welding, gluing, covering, sandwiching, or simply a panel with sufficient stiffness or rigidity as large wall(s) of the shell 10.

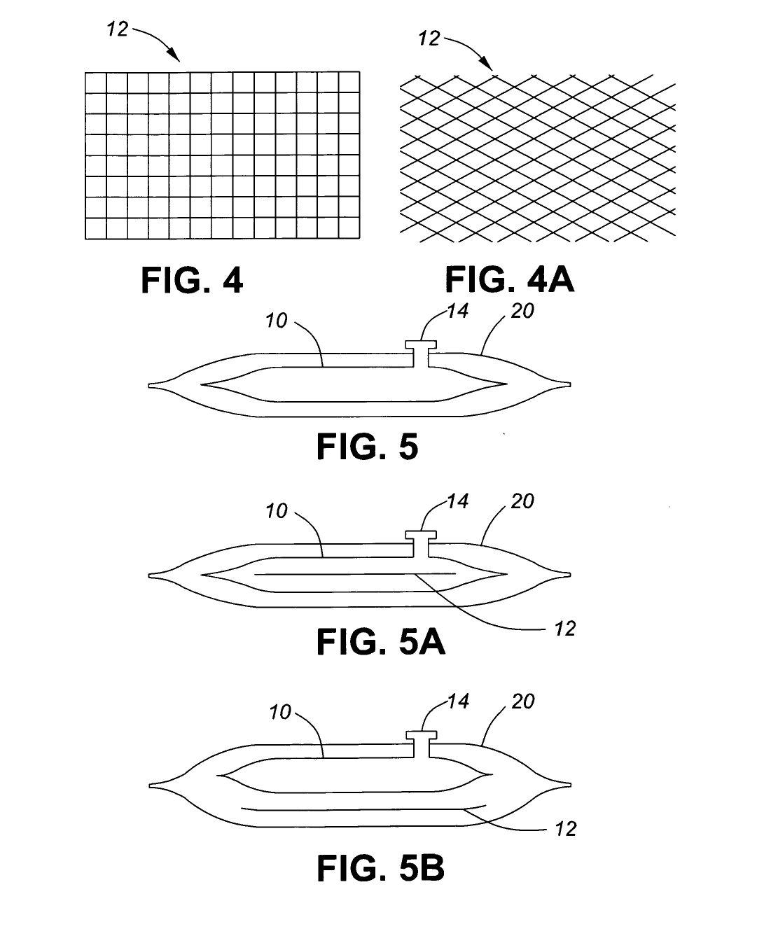

Two embodiments of the stiffening element 12 are illustrated in FIG. 4 (a perforated sheet) and FIG. 4a (openwork structure). The element is basically two-dimensional as its thickness need only be sufficient to afford a reasonable rigidity to maintain the flat form of the shell as explained herein. A plain flat sheet stiffening element does not require illustration.

Turning now to FIGS. 5, 5a and 5b, the cushion may be equipped with a cover 20. It may serve a stiffening function by virtue of the rigidity of its material (e.g. a polymeric material) when the shell has no stiffening element, as shown in FIG. 5. In another embodiment (FIG. 5a) the stiffening element 12 is disposed within the shell 10 and the cover may be floppy and mainly serve decorative, protective or texture-variation purposes. The stiffening element 12 may also be placed between the shell and the cover as shown in FIG. 5b. The port or ports 14 are placed so as not to interfere with the cover and vice versa. It is intended that the cover assumes a flat form, corresponding to the flat form of the shell when the shell is empty, and allows for the inflation of the shell.

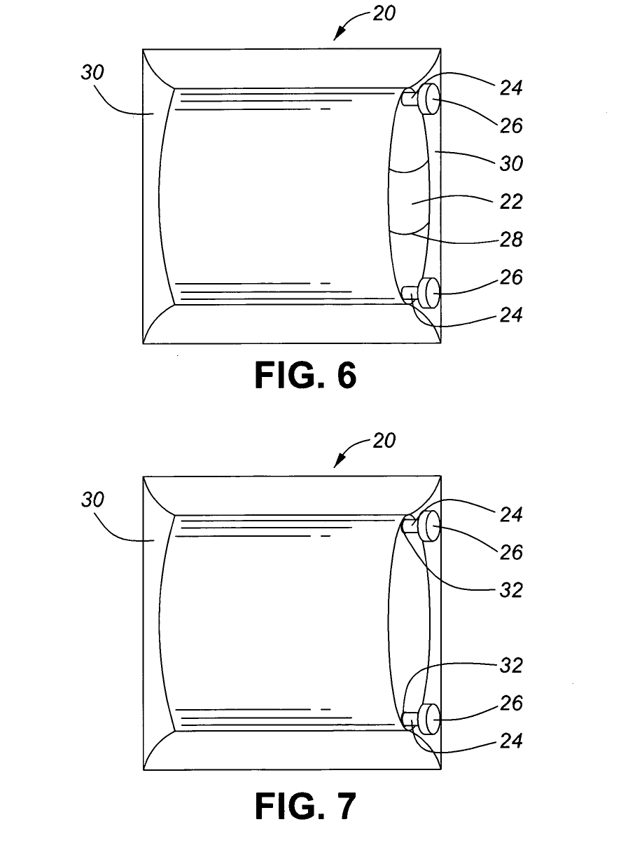

FIG. 6 shows a back view of the cover 20 with the shell inside it (not shown). The cover has a side opening (slit) 22 for easy insertion and removal of the shell and for easy access to and operation of the port fittings 24 as well as closure means 26. The slit 22 can be tied and closed by strings 28 if desired. The cover 20 may have outside “margins” 30 for decorative purposes. The port fittings 24 are placed in the opening 22 of the cover.

FIG. 7 shows an embodiment wherein the port fittings 24 protrude through openings 32 in the cover 20 for easy access and operation of the closure means 26.

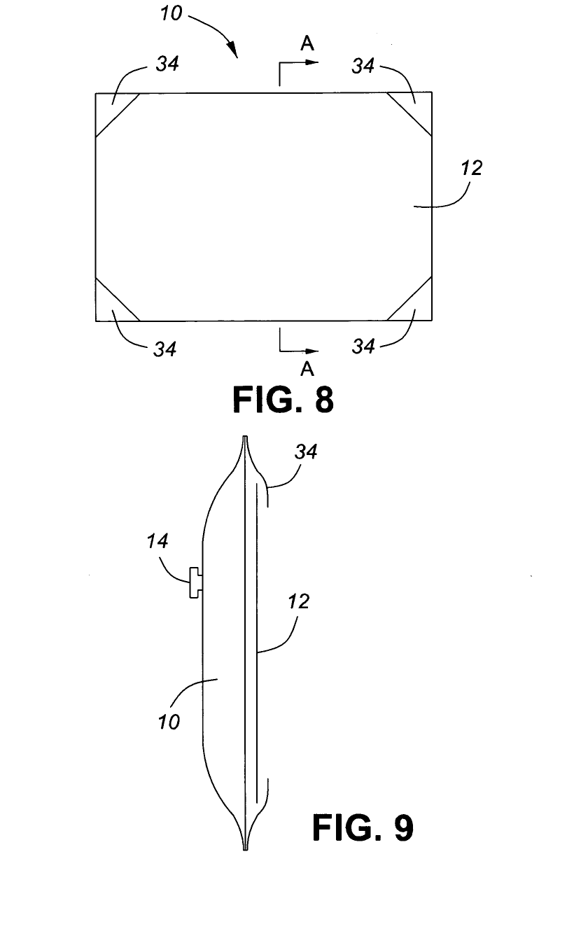

FIG. 8 shows an alternative embodiment of the cushion device. One of the large surfaces of the shell 10 has pockets 34 on the outside, located at the corners. The pockets serve to hold a stiffening element 12 (shown in FIG. 9) which can be embodied by a flat sheet having some rigidity or stiffness sufficient to maintain a substantially flat form of the shell when empty for ease of handling, transportation and storage. As explained hereinabove, the stiffening element is selected not to impede bending of the shell and filling it with a gas or liquid for a satisfactory expansion. The provision of the element 12 on the outside of the shell eliminates the need for another stiffening element inside the shell.

As stated hereinabove, the cushion device of the invention may also be used for therapeutic heating, therapeutic cooling and for lumbar muscular and spinal exercising, typically defined by the medical profession as proprioception.

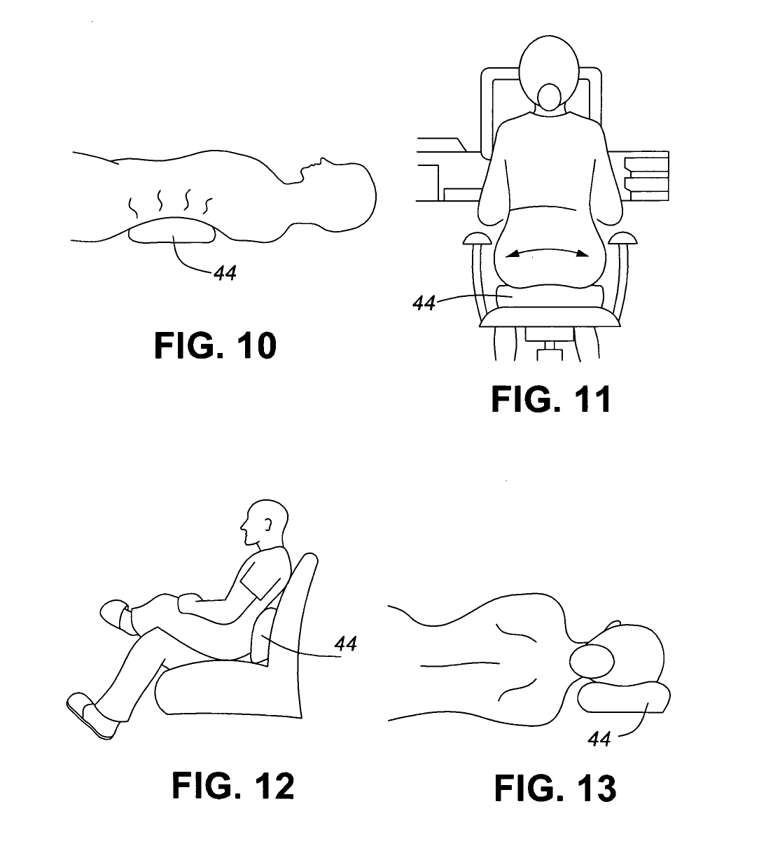

For the therapeutic heating or cooling use as illustrated in FIG. 10 where the cushion is designated as 44, the device, in the single-port or multi-port version, is filled with adequately hot or cold liquid, e.g. water, and then, with the port or ports closed, it is placed in a bed, on a sofa, chair etc. to warm or cool a user's body, e.g. legs, neck, lumbar region etc. in need of such treatment.

Alternatively, the cushion device may be filled with gas or liquid to a desired degree and placed, with its port or ports closed, on a chair in a “horizontal” position, i.e. with one of its large surfaces facing up. The user may now sit on the cushion and balance his/her hips and lumbar region similarly as on a large medical balancing ball, thus exercising the lumbar spine and the associated muscles, especially the hard to reach deep and small muscles in their back and spine, as illustrated in FIG. 11 where the cushion is designates as 44. This beneficial exercise can thus be combined with work and home life.

As stated hereinabove, the cushion device of the invention may also be used for supporting backs and other body parts in dry environment such as chairs, sofas, car seats, beds etc. To this end the cushion may be filled with gas to a desired level and be placed, with port or ports closed, in a chair in a sufficiently “vertical” position. The user may now sit on or lean against said cushion to obtain desired support as illustrated in FIG. 12.

As stated hereinabove, the cushion device of the invention may also be used as a sleeping support to help maintain healthy alignment between head and spine of a person during sleep. To this end the cushion may be filled with gas or liquid to a desired level and be placed, with port or ports closed, flat in bed. The user may now rest their head on said cushion to obtain desired support as illustrated in FIG. 13.

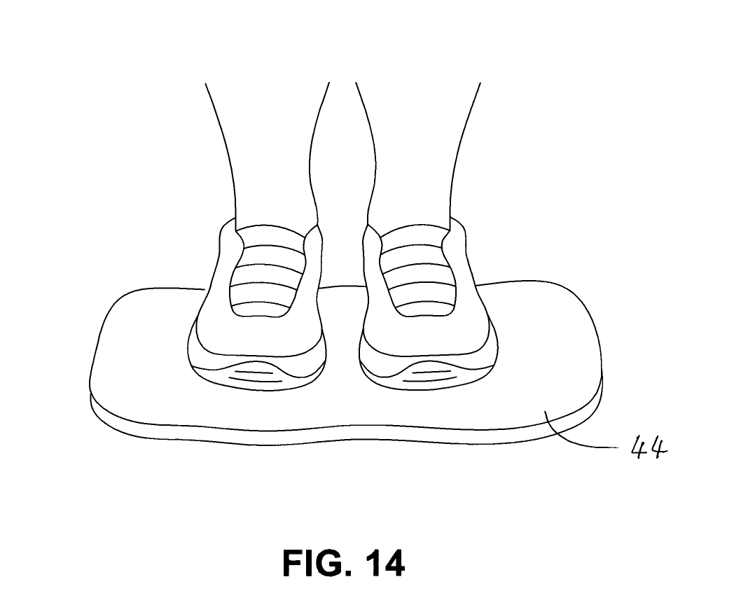

As stated hereinabove, the cushion device of the invention may also be used as a safe balance trainer allow persons stand on it for functional balance training, knee and ankle rehabilitation, etc. To this end the cushion may be filled with gas or liquid to a desired level and be placed, with port or ports closed, flat on the floor. The user may now gently step on said cushion to conduct various balance trainings as illustrated in FIG. 14.

It is recommended that, for sitting on the cushion, the cushion device be designed, shaped and dimensioned to fit an average chair seat, a car seat or a airplane seat, and to be capable of providing suitable proprioceptive benefits. This corresponds approximately to a shape with, dependent on occupant's size, condition and purpose, a length between 15″ and 19″ or between 15″ and 17″, a width between 10″ and 16″ or between 10″ and 13″. Dependent on occupant's condition and purpose, the vertical height is, when filled, between 0.5″ and 1.5″, or between 0.5″ and 1.25″, or between 0.5″ and 1″.

It is recommended that, for standing on the cushion, the cushion device be designed, shaped and dimensioned to be suitable for occupants to stand on it conveniently with one foot or both feet on said device, and to be capable of providing suitable proprioceptive, neuromuscular and functional balance exercises and trainings. This corresponds approximately to a shape with a length between 15″ and 28″, a width between 10″ and 18″. Dependent on occupant's condition and purpose, the vertical height is, when filled, between 1″ and 2″, or between 1″ and 1.75″, or between 1″ and 1.5″, or between 1″ and 1.25″.

It is noted that the dimensional characteristic of the cushion device of the invention does not necessarily imply a rectangular shape. It may have an oval shape, a kidney shape, a dog-bone shape, H-shape, diamond-shape, polygonal shape, or any other shape suitable for the health and therapeutic purposes discussed hereinabove.

Although the description above contains many specifics, these should not be construed as limiting the scope of the invention but as merely providing illustrations of some of the presently preferred embodiments of this invention. For example, the cushion device can have various shapes (subject to the limitations defined herein), gas and fluid control port or ports can be mounted at various positions in various numbers, the insert means can be formed integrally with the shell of the cushion, the gas and liquid control ports or port fittings can also be formed integrally with said shell. The control port or ports can be closed by closure means such as plug-in caps, screw-on caps, snap-on caps, flat sliding closures, rotational cylinder closures, etc.

Thus the scope of the invention should be determined by the appended claims and their legal equivalents, rather than by the examples given.

I claim:

1. A cushion device comprising:
a flexible, hollow, enclosed shell having two large opposed surfaces, the shell being capable of containing gas or liquid without substantial leakage,
at least one port in the shell for ingress or egress of gas or liquid, said port or ports being provided with closure means, and
means for maintaining a substantially planar, or flat, form of the shell when the shell is substantially empty and no substantial bending force is applied onto the shell.

2. The device of claim 1 wherein the means for maintaining the shell in a substantially flat form are stiffness, firmness or rigidity of the shell, the stiffness, firmness or rigidity selected to allow the filling of the shell with a fluid and bending of the shell using a reasonable force.

3. The device of claim 1 wherein the means for maintaining the shell in a substantially flat form is a substantially two-dimensional stiffening element associated with the shell, the stiffening element having sufficient firmness, rigidity or stiffness to maintain the shell in a substantially flat form when the shell is open to ambient atmosphere while allowing the filling of the shell with a fluid and bending of the shell using a reasonable force, or to maintain a substantially planar, or flat, form of the shell when the shell is substantially empty and no substantial bending force is applied onto the shell.

4. The device of claim 3 wherein the stiffening element is a sheet of a semi-rigid material.

5. The device of claim 3 wherein the stiffening element is a foraminous, openwork sheet, netting material or lattice structure.

6. The device of claim 3 wherein the stiffening element is disposed within the shell.

7. The device according to claim 3 wherein the stiffening element is disposed outside the shell.

8. The device according to claim 3 wherein the stiffening element is integrated with a wall of the shell.

9. The device according to claim 1 further comprising a cover encompassing the shell.

10. The device according to claim 9 wherein the cover is semi-rigid and shaped to maintain the shell in a flat form when the shell is empty.

11. The device according to claim 7 wherein the shell has means for holding the stiffening element.

12. The device according to claim 2 wherein the rigidity, firmness or stiffness of the shell is such as to allow inflation of the shell and a return of the shell when deflated to a flat form.

13. A cushion device comprising:
a flexible, hollow, enclosed shell having two large opposed surfaces, the shell being capable of containing gas or liquid without substantial leakage,
at least one port in the shell for ingress or egress of gas or liquid, said port or ports being provided with closure means, and
means for maintaining a substantially flat form of the shell and substantially no internal volume when the port or ports are open to ambient atmosphere and no substantial bending force is applied onto the shell.

14. The device of claim 13 wherein the means for maintaining the shell in a substantially flat form are stiffness, firmness or rigidity of the shell, the stiffness, firmness or rigidity selected to allow the filling of the shell with a fluid and bending of the shell using a reasonable force.

15. The device of claim 13 wherein the means for maintaining the shell in a substantially flat form is a substantially two-dimensional stiffening element associated with the shell, the stiffening element having sufficient firmness, rigidity or stiffness to maintain the shell in a substantially flat form when the shell is open to ambient atmosphere while allowing the filling of the shell with a fluid and bending of the shell using a reasonable force, or to maintain a substantially planar, or flat, form of the shell when the shell is substantially empty and no substantial bending force is applied onto the shell.

16. The device of claim 15 wherein the stiffening element is a sheet of a semi-rigid material.

17. The device of claim 15 wherein the stiffening element is a foraminous, openwork sheet, netting material or lattice structure.

18. The device of claim 15 wherein the stiffening element is disposed within the shell.

19. The device according to claim 15 wherein the stiffening element is disposed outside the shell.

20. The device according to claim 15 wherein the stiffening element is integrated with a wall of the shell.

21. The device according to claim 13 further comprising a cover encompassing the shell.

22. The device according to claim 21 wherein the cover is semi-rigid and shaped to maintain the shell in a flat form when the shell is empty.

23. The device according to claim 19 wherein the shell has means for holding the stiffening element.

24. The device according to claim 14 wherein the rigidity, firmness or stiffness of the shell is such as to allow inflation of the shell and a return of the shell when deflated, to a flat form.

25. The cushion device according to claim 1 having a length of between 15 in. and 28 in. and a width between 10 in. and 18 in.

26. The cushion device according to claim 1 having a length of between 15 in. and 19 in. and a width between 10 in. and 16 in.

27. The cushion device according to claim 1 having a length of between 15 in. and 17 in. and a width between 10 in. and 13 in.

28. The cushion device according to claim 13 having a length of between 15 in. and 28 in. and a width between 10 in. and 18 in.

29. The cushion device according to claim 13 having a length of between 15 in. and 19 in. and a width between 10 in. and 16 in.

30. The cushion device according to claim 13 having a length of between 15 in. and 17 in. and a width between 10 in. and 13 in.

31. A method of therapeutic stimulation of a person's body, and particularly lower back region, the method comprising:
providing an inflatable cushion having a shell with a length from about 15 in. to about 19 in. in length and about 10 in. to 16 in. in width,
inflating the cushion partly or fully with a fluid so that the height, or thickness of the cushion when placed on a flat surface is from about 0.5 in. to about 1.5 in., and
using the cushion by sitting on it whereby the occupant performs or receives one or more exercises selected from the group consisting of proprioceptive, neuromuscular, functional balance, equilibrious, isotonic, isometric, therapeutic and range-of-motion exercises of the lumbosacral spine and muscles, pelvis, abdomen, gluteal and thigh regions to promote enhanced mobility, stability, strength, proprioception, equilibrium and other related health conditions of the occupant's body in comparison to passive sitting.

32. The method according to claim 31 wherein the cushion is inflated partly or fully with a fluid so that the height, or thickness of the cushion when placed on a flat surface is from about 0.5 in to about 1.25 in.

33. The method according to claim 31 wherein the cushion is inflated partly or fully with a fluid so that the height, or thickness of the cushion when placed on a flat surface is from about 0.5 in to about 1 in.

34. The method according to claim 31 wherein the cushion has a flat stiffening means for maintaining the cushion, when deflated, in a flat form.

35. The method according to claim 31 further comprising a step of using said apparatus to enhance low back stabilization, coordination, strength, flexibility, and proprioceptive senses while an occupant is seated.

36. A method of therapeutic stimulation of a person's body, and particularly lower back region, the method comprising:
providing an inflatable cushion having a shell with a length from about 15 to about 28 in. in length and about 10 to 18 in. in width,
inflating the cushion partly or fully with a fluid so that the height, or thickness of the cushion when placed on a flat surface is from about 1 in. to about 2 in., and
using the cushion by standing on it whereby the occupant performs or receives one or more exercises selected from the group consisting of proprioceptive, neuromuscular, functional balance, equilibrious, isotonic, isometric, therapeutic and range-of-motion exercises of the ankle, knee, leg, thigh, gluteal, pelvis, abdomen, spine, trunk, upper body and upper extremity regions to promote enhanced mobility, stability, strength, proprioception, equilibrium, functional balance and other related health conditions of the occupant's body in comparison to standing on conventional balance training devices such as balance boards or balance balls.

37. The method according to claim 36 wherein the cushion is inflated partly or fully with a fluid so that the height, or thickness of the cushion when placed on a flat surface is from about 1 in. to about 1.75 in.

38. The method according to claim 36 wherein the cushion is inflated partly or fully with a fluid so that the height, or thickness of the cushion when placed on a flat surface is from about 1 in. to about 1.5 in.

39. The method according to claim 36 wherein the cushion is inflated partly or fully with a fluid so that the height, or thickness of the cushion when placed on a flat surface is from about 1 in. to about 1.25 in.

40. The method according to claim 36 wherein the cushion has a flat stiffening means for maintaining the cushion, when deflated, in a flat form.
